(19) United States
(12) Patent Application Publication
(10) Pub. No.: US 2024/0063378 A1
(43) Pub. Date: Feb. 22, 2024

(54) ELECTRODE MATERIAL AND BATTERY

(71) Applicant: Panasonic Intellectual Property Management Co., Ltd., Osaka (JP)

(72) Inventors: AKIHIKO SAGARA, Nara (JP); TAKASHI OTO, Osaka (JP)

(21) Appl. No.: 18/500,514

(22) Filed: Nov. 2, 2023

Related U.S. Application Data
(63) Continuation of application No. PCT/JP2022/004783, filed on Feb. 8, 2022.

(30) Foreign Application Priority Data
May 31, 2021 (JP) 2021-091878

(51) Int. Cl. H01M 4/485; H01M 4/04; H01M 4/36; H01M 4/48; H01M 10/0562

(52) U.S. Cl. CPC H01M 4/485; H01M 4/0407; H01M 4/364; H01M 4/48; H01M 10/0562; H01M 2300/008

(57) ABSTRACT

An electrode material according to an aspect of the present disclosure includes a first active material containing Li, Ti, and O, a second active material containing Mo and O, and a solid electrolyte. A battery according to an aspect of the present disclosure includes a first electrode, a second electrode, and an electrolyte layer arranged between the first electrode and the second electrode. At least one selected from the group consisting of the first electrode and the second electrode includes the electrode material.

### BACKGROUND

### 1. Technical Field

The present disclosure relates to an electrode material and a battery.

### 2. Description of the Related Art

WO 2019/146295 discloses a negative electrode material that includes lithium titanate as a negative electrode active material and a halide solid electrolyte, and a battery using the same.

### SUMMARY

In the conventional art, there is a demand that charge-discharge efficiency and discharge capacity be satisfied at the same time.

In one general aspect, the techniques disclosed here feature an electrode material including a first active material containing Li, Ti, and O, a second active material containing Mo and O, and a solid electrolyte.

According to the present disclosure, charge-discharge efficiency and discharge capacity can be satisfied at the same time.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a sectional view illustrating a schematic configuration of an electrode material according to Embodiment 1;

FIG. 2 is a sectional view illustrating a schematic configuration of a battery according to Embodiment 2; and

FIG. 3 is a graph illustrating results of an initial charge-discharge test of a battery of EXAMPLE 4.

### DETAILED DESCRIPTIONS

### Underlying Knowledge Forming Basis of the Present Disclosure

WO 2019/146295 discloses a battery that uses a negative electrode material including lithium titanate as a negative electrode active material. Batteries using lithium titanate are known to exhibit high charge-discharge efficiency. Furthermore, lithium titanate is unlikely to cause deposition of lithium metal. Thus, the use of lithium titanate in a negative electrode makes it possible to prevent an internal short circuit caused by the metal deposits penetrating an electrolyte layer and coming into contact with a positive electrode. Furthermore, lithium titanate is characterized by its small expansion and contraction associated with insertion and extraction of lithium ions. Thus, the use of lithium titanate as an active material can enhance the battery safety. On the other hand, lithium titanate disadvantageously has a small capacity per mass.

The present inventors carried out extensive studies on techniques that would satisfy both charge-discharge efficiency and discharge capacity, and have developed the technique of the present disclosure as a result.

### Summary of Aspects of the Present Disclosure

An electrode material according to the first aspect of the present disclosure includes:
a first active material containing Li, Ti, and O;
a second active material containing Mo and O; and
a solid electrolyte.

The first active material containing Li, Ti, and O enhances the battery charge-discharge efficiency. The second active material containing Mo and O enhances the battery discharge capacity. Thus, both charge-discharge efficiency and discharge capacity can be satisfied according to the above configuration.

In the second aspect of the present disclosure, for example, the electrode material according to the first aspect may be such that the ratio of the mass of the first active material to the total mass of the first active material and the second active material is greater than or equal to 50% and less than or equal to 99%. Upon insertion and extraction of lithium ions, the first active material expands less and contracts less than the second active material. Thus, the above configuration can enhance the battery safety while satisfying both the battery charge-discharge efficiency and the battery discharge capacity.

In the third aspect of the present disclosure, for example, the electrode material according to the second aspect may be such that the ratio is greater than or equal to 70% and less than or equal to 95%. This configuration can further enhance the battery safety while satisfying both the battery charge-discharge efficiency and the battery discharge capacity.

In the fourth aspect of the present disclosure, for example, the electrode material according to any one of the first to the third aspects may be such that the first active material includes lithium titanium oxide. According to this configuration, both charge-discharge efficiency and discharge capacity are satisfied more reliably.

In the fifth aspect of the present disclosure, for example, the electrode material according to the fourth aspect may be such that the lithium titanium oxide includes Li₄Ti₅O₁₂. According to this configuration, both charge-discharge efficiency and discharge capacity are satisfied more reliably.

In the sixth aspect of the present disclosure, for example, the electrode material according to any one of the first to the fifth aspects may be such that the second active material includes molybdenum oxide. According to this configuration, both charge-discharge efficiency and discharge capacity are satisfied more reliably.

In the seventh aspect of the present disclosure, for example, the electrode material according to the sixth aspect may be such that the molybdenum oxide includes MoO₂. According to this configuration, both charge-discharge efficiency and discharge capacity are satisfied more reliably.

In the eighth aspect of the present disclosure, for example, the electrode material according to any one of the first to the seventh aspects may be such that the solid electrolyte contains Li, M, and X. M is at least one selected from the group consisting of metal elements except Li, and metalloid elements. X is at least one selected from the group consisting of F, Cl, Br, and I. According to this configuration, battery output characteristics can be enhanced.

In the ninth aspect of the present disclosure, for example, the electrode material according to the eighth aspect may be such that the solid electrolyte is represented by formula (1) below:

Li_{α}M_{β}X_{γ} Formula (1)

Here, α, β, and γ are each independently a value greater than 0. According to this configuration, battery output characteristics can be further enhanced.

In the tenth aspect of the present disclosure, for example, the electrode material according to the ninth aspect may be such that the solid electrolyte includes Li₃YBr₂Cl₂I₂. According to this configuration, battery output characteristics can be further enhanced.

In the eleventh aspect of the present disclosure, for example, the electrode material according to any one of the eighth to the tenth aspects may be such that the solid electrolyte does not contain sulfur. According to this configuration, the battery safety can be enhanced.

A battery according to the twelfth aspect of the present disclosure includes:
a first electrode; a second electrode; and an electrolyte layer arranged between the first electrode and the second electrode, wherein at least one selected from the group consisting of the first electrode and the second electrode includes the electrode material according to any one of the first to the eleventh aspects.

The battery according to the above configuration can satisfy both charge-discharge efficiency and discharge capacity.

Hereinafter, embodiments of the present disclosure will be described with reference to the drawings.

### Embodiment 1

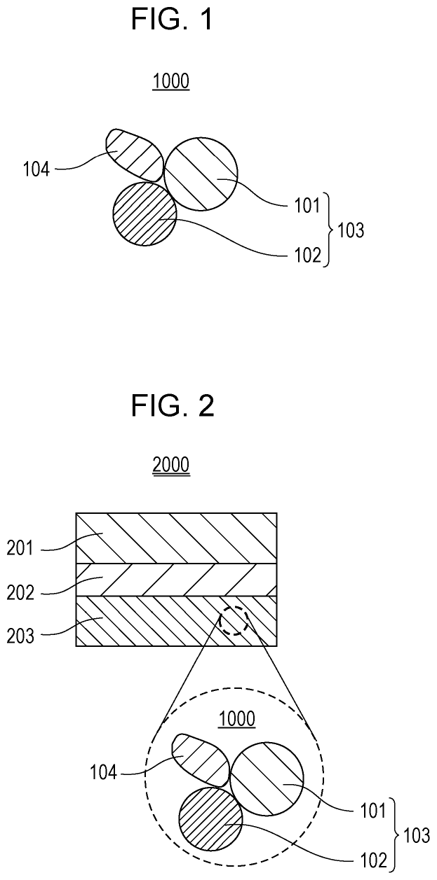

FIG. 1 is a sectional view illustrating a schematic configuration of an electrode material 1000 according to Embodiment 1.

The electrode material 1000 includes an active material 103 and a solid electrolyte 104. The active material 103 includes a first active material 101 containing Li, Ti, and O, and a second active material 102 containing Mo and O.

The first active material 101 containing Li, Ti, and O enhances the battery charge-discharge efficiency. The second active material 102 containing Mo and O enhances the battery discharge capacity. Thus, the use of the electrode material 1000 allows for satisfaction of both charge-discharge efficiency and discharge capacity.

The active material 103 may include only the first active material 101 and the second active material 102. In the present disclosure, the phrase “include only the first active material 101 and the second active material 102” means that materials other than the first active material 101 and the second active material 102, except incidental impurities, are not intentionally added to the active material 103. For example, incidental impurities include ingredients for the first active material 101 and the second active material 102, and by-products occurring during preparation of the first active material 101 and the second active material 102. The same applies to other materials.

The ratio of the mass of the first active material 101 to the total mass of the first active material 101 and the second active material 102 may be greater than or equal to 50% and less than or equal to 99%. Upon insertion and extraction of lithium ions, the first active material 101 expands less and contracts less than the second active material 102. Thus, the above configuration can enhance the battery safety while satisfying both the battery charge-discharge efficiency and the battery discharge capacity.

For example, the ratio of the mass of the first active material 101 to the total mass of the first active material 101 and the second active material 102 may be calculated from the respective volumes of the first active material 101 and the second active material 102. Specifically, the mass of the first active material 101 and that of the second active material 102 may be calculated by multiplying the respective volumes of the first active material 101 and the second active material 102 by the respective densities of the first active material 101 and the second active material 102. The ratio of the mass of the first active material 101 to the total mass of the first active material 101 and the second active material 102 can be calculated from the respective masses of the first active material 101 and the second active material 102 calculated above. For example, the respective volumes of the first active material 101 and the second active material 102 may be measured with respect to sectional SEM images obtained with a scanning electron microscope (SEM). For example, the respective densities of the first active material 101 and the second active material 102 may be measured with a pycnometer.

The ratio of the mass of the first active material 101 to the total mass of the first active material 101 and the second active material 102 may be greater than or equal to 70% and less than or equal to 95%. According to this configuration, the battery safety can be further enhanced.

The ratio of the mass of the first active material 101 to the total mass of the first active material 101 and the second active material 102 may be greater than or equal to 75% and less than or equal to 80%. According to this configuration, the battery safety can be further enhanced.

The first active material 101 may include lithium titanium oxide. According to this configuration, both charge-discharge efficiency and discharge capacity are satisfied more reliably.

The first active material 101 may include lithium titanium oxide as a main component. In the present disclosure, the term “main component” means that the component represents a mass ratio of greater than or equal to 50%.

The first active material 101 may include lithium titanium oxide in a mass ratio of greater than or equal to 70% relative to the whole of the first active material 101.

The first active material 101 may be lithium titanium oxide.

Examples of the lithium titanium oxides include Li₄Ti₅O₁₂, Li₇Ti₅O₁₂, and LiTi₂O₄. When the first active material 101 includes lithium titanium oxide, the lithium titanium oxide may include at least one selected from these materials.

The lithium titanium oxide may include Li₄Ti₅O₁₂. According to the above configurations, both charge-discharge efficiency and discharge capacity are satisfied more reliably.

The lithium titanium oxide may be Li₄Ti₅O₁₂.

The second active material 102 may include molybdenum oxide. According to this configuration, both charge-discharge efficiency and discharge capacity are satisfied more reliably.

The second active material 102 may include molybdenum oxide as a main component.

The second active material 102 may include molybdenum oxide in a mass ratio of greater than or equal to 70% relative to the whole of the second active material 102.

The second active material 102 may be molybdenum oxide.

Examples of the molybdenum oxides include MoO₂.

The molybdenum oxide may include MoO₂. According to the above configurations, both charge-discharge efficiency and discharge capacity are satisfied more reliably.

The molybdenum oxide may be MoO₂.

The solid electrolyte 104 may contain Li, M, and X. Here, M is at least one selected from the group consisting of metal elements except Li, and metalloid elements. X is at least one selected from the group consisting of F, Cl, Br, and I. According to this configuration, the solid electrolyte 104 can attain enhanced ion conductivity and thereby can offer enhanced battery output characteristics.

In the present disclosure, the “metalloid elements” are B, Si, Ge, As, Sb, and Te. The “metal elements” indicate all the elements found in Groups 1 to 12 of the periodic table except hydrogen, and all the elements found in Groups 13 to 16 of the periodic table except B, Si, Ge, As, Sb, Te, C, N, P, O, S, and Se. That is, the “metalloid elements” or the “metal elements” are a group of elements that can form an inorganic compound with a halogen element by becoming a cation.

The solid electrolyte 104 may consist essentially of Li, M, and X. The phrase “consist essentially of Li, M, and X” means that the molar ratio (that is, the molar fraction) of the total of the amounts of substance of Li, M, and X in the solid electrolyte 104 to the total of the amounts of substance of all the elements constituting the solid electrolyte 104 is greater than or equal to 90%. As an example, the molar ratio may be greater than or equal to 95%.

The solid electrolyte 104 may consist solely of Li, M, and X. The phrase “consist solely of Li, M, and X” means that the molar ratio of the total of the amounts of substance of Li, M, and X in the solid electrolyte 104 to the total of the amounts of substance of all the elements constituting the solid electrolyte 104 is 100%.

The solid electrolyte 104 may be represented by the formula (1) below:

Li_{α}M_{β}X_{γ} Formula (1)

In the formula (1), α, β, and γ are each independently a value greater than 0. According to the above configuration, the solid electrolyte 104 can attain still enhanced ion conductivity and thereby can offer further enhanced battery output characteristics.

When the solid electrolyte 104 contains Li, M, and X, M may include at least one selected from the group consisting of Group 1 elements, Group 2 elements, Group 3 elements, Group 4 elements, and lanthanoid elements. According to this configuration, the ion conductivity of the solid electrolyte 104 can be further enhanced.

Examples of the Group 1 elements include Na, K, Rb, and Cs. Examples of the Group 2 elements include Mg, Ca, Sr, and Ba. Examples of the Group 3 elements include Sc and Y. Examples of the Group 4 elements include Ti, Zr, and Hf. Examples of the lanthanoid elements include La, Ce, Pr, Nd, Sm, Eu, Gd, Tb, Dy, Ho, Er, Tm, Yb, and Lu.

When the solid electrolyte 104 contains Li, M, and X, M may include at least one selected from the group consisting of Group 5 elements, Group 12 elements, Group 13 elements, and Group 14 elements. According to this configuration, the ion conductivity of the solid electrolyte 104 can be further enhanced.

Examples of the Group 5 elements include Nb and Ta. Examples of the Group 12 elements include Zn. Examples of the Group 13 elements include Al, Ga, and In. Examples of the Group 14 elements include Sn.

When the solid electrolyte 104 contains Li, M, and X, M may include at least one selected from the group consisting of Na, K, Mg, Ca, Sr, Ba, Sc, Y, Zr, Hf, La, Ce, Pr, Nd, Sm, Eu, Gd, Tb, Dy, Ho, Er, Tm, Yb, and Lu. According to this configuration, the ion conductivity of the solid electrolyte 104 can be further enhanced.

When the solid electrolyte 104 contains Li, M, and X, M may include at least one selected from the group consisting of Mg, Ca, Sr, Y, Sm, Gd, Dy, and Hf. According to this configuration, the ion conductivity of the solid electrolyte 104 can be further enhanced.

When the solid electrolyte 104 contains Li, M, and X, X may include at least one selected from the group consisting of Br, Cl, and I. According to this configuration, the ion conductivity of the solid electrolyte 104 can be further enhanced.

When the solid electrolyte 104 contains Li, M, and X, X may include Br, Cl, and I. According to this configuration, the ion conductivity of the solid electrolyte 104 can be further enhanced.

When the solid electrolyte 104 contains Li, M, and X, M may include Y (=yttrium). That is, the solid electrolyte 104 may contain Y as a metal element. According to this configuration, the ion conductivity of the solid electrolyte 104 can be further enhanced.

When the solid electrolyte 104 contains Li, M, and X, M may be Y (=yttrium).

When the solid electrolyte 104 contains Y, the solid electrolyte 104 may be represented by the formula (2) below:

Li₃YX₆ Formula (2)

In the formula (2), X is at least one selected from the group consisting of F, Cl, Br, and I.

When the solid electrolyte 104 contains Y, the solid electrolyte 104 may be represented by the formula (3) below:

Li₃YBrₓCl₆₋ₓ Formula (3)

In the formula (3), 0≤x≤6 is satisfied.

When the solid electrolyte 104 contains Y, the solid electrolyte 104 may be represented by the formula (4) below:

Li₃YBrₓCl_{y}I_{6-x-y} Formula (4)

In the formula (4), 0≤x≤6 and 0≤y≤6 are satisfied.

More specifically, the solid electrolyte 104 may be at least one selected from the group consisting of Li₃YCl₆, Li₃YBr₆, Li₃YBr₂Cl₄, and Li₃YBr₂Cl₂I₂.

The solid electrolyte 104 may include Li₃YBr₂Cl₂I₂. According to the above configurations, the solid electrolyte 104 can attain still enhanced ion conductivity and thus can offer further enhanced battery output characteristics.

The solid electrolyte 104 may include Li₃YBr₂Cl₂I₂ as a main component.

The solid electrolyte 104 may include Li₃YBr₂Cl₂I₂ in a mass ratio of greater than or equal to 70% relative to the whole of the solid electrolyte 104.

The solid electrolyte 104 may be Li₃YBr₂Cl₂I₂.

The solid electrolyte 104 may not contain sulfur. This configuration can eliminate the generation of hydrogen sulfide gas and thus can enhance the battery safety.

The shape of the solid electrolyte 104 is not limited. For example, the shape of the solid electrolyte 104 may be acicular, spherical, ellipsoidal, or fibers. For example, the shape of the solid electrolyte 104 may be particulate. The solid electrolyte 104 may be formed to have a pellet or plate shape.

When the solid electrolyte 104 is particles (for example, spherical particles), the median diameter of the solid electrolyte 104 may be greater than or equal to 0.1 μm and less than or equal to 100 μm. According to this configuration, the active material 103 and the solid electrolyte 104 may be favorably dispersed in an electrode. Thus, battery charge-discharge characteristics are enhanced.

In the present disclosure, the “median diameter” means the particle size at 50% cumulative volume in the volume-based grain size distribution. For example, the volume-based grain size distribution is measured with a laser diffraction measurement device or an image analyzer.

The median diameter of the solid electrolyte 104 may be greater than or equal to 0.5 μm and less than or equal to 10 μm. According to this configuration, the active material 103 and the solid electrolyte 104 may be more favorably dispersed in an electrode.

The shape of the active material 103 is not limited. Specifically, for example, the shapes of the first active material 101 and the second active material 102 may be acicular, spherical, or ellipsoidal. For example, the shapes of the first active material 101 and the second active material 102 may be particulate.

When the active material 103 is particles (for example, spherical particles), the median diameter of the active material 103 may be greater than or equal to 0.1 μm and less than or equal to 100 μm. When the median diameter of the active material 103 is greater than or equal to 0.1 μm, the active material 103 and the solid electrolyte 104 may be favorably dispersed in an electrode. Thus, battery charge-discharge characteristics are enhanced. When the median diameter of the active material 103 is less than or equal to 100 μm, the lithium diffusion rate in the inside of the active material 103 is enhanced, thus allowing a battery to be operated at a high output.

The median diameter of the active material 103 may be larger than the median diameter of the solid electrolyte 104. According to this configuration, the active material 103 and the solid electrolyte 104 may be favorably dispersed in an electrode.

When the active material 103 is particles (for example, spherical particles), the median diameter of the first active material 101 may be larger than the median diameter of the second active material 102. The median diameter of the first active material 101 may be smaller than the median diameter of the second active material 102. The median diameter of the first active material 101 may be equal to the median diameter of the second active material 102.

At least one selected from the group consisting of the first active material 101 and the second active material 102 may be coated with a coating material. Both the first active material 101 and the second active material 102 may be coated with a coating material. Either the first active material 101 or the second active material 102 may be coated with a coating material.

A material with low electron conductivity may be used as the coating material. Examples of the coating materials that may be used include oxide materials and oxide solid electrolytes.

Examples of the oxide materials that may be used include SiO₂, Al₂O₃, TiO₂, B₂O₃, Nb₂O₅, WO₃, and ZrO₂.

Examples of the oxide solid electrolytes that may be used as the coating materials include Li—Nb—O compounds, such as LiNbO₃; Li—B—O compounds, such as LiBO₂ and Li₃BO₃; Li—Al—O compounds, such as LiAlO₂; Li—Si—O compounds, such as Li₄SiO₄; Li₂SO₄; Li—Ti—O compounds, such as Li₄Ti₅O₁₂; Li—Zr—O compounds, such as Li₂ZrO₃; Li—Mo—O compounds, such as Li₂MoO₃; Li—V—O compounds, such as LiV₂O₅; and Li—W—O compounds, such as Li₂WO₄.

The coating material may be an oxide solid electrolyte.

Oxide solid electrolytes have high ion conductivity. Oxide solid electrolytes have excellent high-potential stability. Thus, battery charge-discharge efficiency can be further enhanced by using an oxide solid electrolyte as the coating material.

The coating material may uniformly cover the active material 103 (the first active material 101 and/or the second active material 102). In this case, the coating material keeps the active material 103 away from direct contact with the solid electrolyte 104 and thus can suppress side reactions of the solid electrolyte 104. Thus, battery charge-discharge efficiency can be enhanced.

The coating material may cover part of the active material 103 (part of the first active material 101 and/or part of the second active material 102). Particles of the active material 103 are placed in direct contact through portions exposed from the coating material, and the electron conductivity is enhanced between particles of the active material 103, thus allowing a battery to be operated at a high output.

In the electrode material 1000, the first active material 101, the second active material 102, and the solid electrolyte 104 may be in contact with one another.

The electrode material 1000 may include particles of the first active material 101, particles of the second active material 102, and particles of the solid electrolyte 104.

In the electrode material 1000, the content of the active material 103 and the content of the solid electrolyte 104 may be equal to or different from each other.

### Electrode Material Producing Methods

For example, the electrode material 1000 may be produced by the following method.

The electrode material 1000 is obtained by mixing the first active material 101, the second active material 102, and the solid electrolyte 104. The first active material 101, the second active material 102, and the solid electrolyte 104 may be mixed in any manner without limitation. For example, the first active material 101, the second active material 102, and the solid electrolyte 104 may be mixed using a tool, such as a mortar, or the first active material 101, the second active material 102, and the solid electrolyte 104 may be mixed using a mixing device, such as a ball mill. The mixing ratio of the first active material 101 and the second active material 102 to the solid electrolyte 104 is not particularly limited.

For example, the solid electrolyte 104 may be produced by the following method.

Ingredient powders are provided in a blend ratio corresponding to the target composition. For example, the ingredient powders may be halides. When, for example, Li₃YBr₂Cl₄ is prepared as the solid electrolyte 104, LiBr, LiCl, and YCl₃ are provided in a molar ratio of 2.0:1.0:1.0. The ingredient powders may be mixed in a molar ratio controlled beforehand so as to compensate for compositional changes expected in the synthesis process.

The kinds of the ingredient powders are not limited to those described above. For example, use may be made of a combination of LiCl and YBr₃, or a composite anion compound, such as LiBr_{0.5}Cl_{0.5}. A mixture of an oxygen-containing ingredient powder (for example, an oxide, a hydroxide, a sulfate, or a nitrate) and a halide (for example, an ammonium halide) may also be used.

The ingredient powders are sufficiently mixed using a mortar and a pestle, a ball mill, or a mixer to give a mixed powder. Next, the mixed powder is pulverized using a mechanochemical milling technique. In this manner, the ingredient powders react to give a solid electrolyte 104. Alternatively, the ingredient powders that have been sufficiently mixed may be heat-treated in vacuum or in an inert atmosphere to give a solid electrolyte 104.

For example, the heat treatment may be performed in the range of temperatures higher than or equal to 100° C. and lower than or equal to 650° C. for at least 1 hour. The solid electrolyte 104 containing a crystal phase is thus obtained.

The configuration of the crystal phase (namely, the crystal structure) in the solid electrolyte 104 may depend on the elements constituting the solid electrolyte 104 (for example, M and X), the ratio of the constituent elements in the solid electrolyte 104, the manner in which the ingredient powders are reacted, and reaction conditions that are selected.

### Embodiment 2

Embodiment 2 will be described below. Descriptions overlapping with those of Embodiment 1 are omitted as appropriate.

FIG. 2 is a sectional view illustrating a schematic configuration of a battery 2000 according to Embodiment 2.

The battery 2000 in Embodiment 2 includes a first electrode 201, an electrolyte layer 202, and a second electrode 203. The electrolyte layer 202 is arranged between the first electrode 201 and the second electrode 203. At least one selected from the group consisting of the first electrode 201 and the second electrode 203 includes the electrode material 1000 in Embodiment 1. FIG. 2 illustrates an example in which the second electrode 203 includes the electrode material 1000.

The battery 2000 according to the above configuration can satisfy both charge-discharge efficiency and discharge capacity.

The first electrode 201 may be a positive electrode. In this case, the second electrode 203 is a negative electrode. The first electrode 201 may be a negative electrode. In this case, the second electrode 203 is a positive electrode.

Both the first electrode 201 and the second electrode 203 may include the electrode material 1000. Either the first electrode 201 or the second electrode 203 may include the electrode material 1000.

When the first electrode 201 is a positive electrode and the second electrode 203 is a negative electrode, the second electrode 203 may include the electrode material 1000. That is, the second electrode 203 may include the active material 103 as a negative electrode active material and the solid electrolyte 104 as a solid electrolyte.

When the first electrode 201 includes the electrode material 1000, the volume ratio “v1:100−v1” between the active material 103 and the solid electrolyte 104 present in the first electrode 201 may satisfy 30≤v1≤95. Here, v1 indicates the volume proportion of the active material 103 relative to the total volume of the active material 103 and the solid electrolyte 104 in the first electrode 201 taken as 100. When 30≤v1 is satisfied, a sufficient energy density of the battery 2000 may be ensured. When v1≤95 is satisfied, the battery 2000 may be operated at a high output.

When the second electrode 203 includes the electrode material 1000, the volume ratio “v2:100−v2” between the active material 103 and the solid electrolyte 104 present in the second electrode 203 may satisfy 30≤v2≤95. Here, v2 indicates the volume proportion of the active material 103 relative to the total volume of the active material 103 and the solid electrolyte 104 in the second electrode 203 taken as 100. When 30≤v2 is satisfied, a sufficient energy density of the battery 2000 may be ensured. When v2≤95 is satisfied, the battery 2000 may be operated at a high output.

The thickness of the first electrode 201 may be greater than or equal to 10 μm and less than or equal to 1000 μm. When the thickness of the first electrode 201 is greater than or equal to 10 μm, a sufficient energy density of the battery 2000 may be ensured. When the thickness of the first electrode 201 is less than or equal to 1000 μm, the battery 2000 may be operated at a high output.

The thickness of the second electrode 203 may be greater than or equal to 10 μm and less than or equal to 1000 μm. When the thickness of the second electrode 203 is greater than or equal to 10 μm, a sufficient energy density of the battery 2000 may be ensured. When the thickness of the second electrode 203 is less than or equal to 1000 μm, the battery 2000 may be operated at a high output.

The electrolyte layer 202 is a layer including an electrolyte. For example, the electrolyte is a solid electrolyte. That is, the electrolyte layer 202 may be a solid electrolyte layer.

The solid electrolyte contained in the electrolyte layer 202 may be a halide solid electrolyte, a sulfide solid electrolyte, an oxide solid electrolyte, a polymeric solid electrolyte, or a complex hydride solid electrolyte.

For example, the halide solid electrolyte that is used may be a material described as the solid electrolyte 104 in Embodiment 1. That is, the electrolyte layer 202 may include a solid electrolyte having the same composition as that of the solid electrolyte 104. According to this configuration, the charge-discharge efficiency of the battery 2000 can be further enhanced.

The electrolyte layer 202 may include a halide solid electrolyte having a composition different from that of the solid electrolyte 104.

The electrolyte layer 202 may include two or more halide solid electrolytes selected from the materials described as the solid electrolytes 104.

The electrolyte layer 202 may include only one halide solid electrolyte selected from the materials described as the solid electrolytes 104.

Examples of the sulfide solid electrolytes that may be used include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂Si₂. For example, LiX, Li₂O, MO_{q}, and LiₚMO_{q} may be added to those described above. Here, X includes at least one selected from the group consisting of F, Cl, Br, and I. M includes at least one selected from the group consisting of P, Si, Ge, B, Al, Ga, In, Fe, and Zn. The letters p and q are each a natural number. One, or two or more sulfide solid electrolytes selected from the above materials may be used.

Examples of the oxide solid electrolytes that may be used include NASICON-type solid electrolytes typified by LiTi₂(PO₄)₃ and element-substituted derivatives thereof; (LaLi)TiO₃ perovskite-type solid electrolytes; LISICON-type solid electrolytes typified by Li₁₄ZnGe₄O₁₆, Li₄SiO₄, LiGeO₄, and element-substituted derivatives thereof; garnet-type solid electrolytes typified by Li₇La₃Zr₂O₁₂ and element-substituted derivatives thereof; Li₃N and H-substituted derivatives thereof; Li₃PO₄ and N-substituted derivatives thereof; and glass and glass ceramics based on Li—B—O compound, such as LiBO₂ or Li₃BO₃ and doped with, for example, Li₂SO₄ or Li₂CO₃.

For example, the polymeric solid electrolyte that is used may be a compound of a polymer compound with a lithium salt. The polymer compound may have an ethylene oxide structure. The polymer compound having an ethylene oxide structure can contain a large amount of a lithium salt, and thus the ion conductivity can be further increased. Examples of the lithium salts that may be used include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One, or two or more lithium salts selected from the above lithium salts may be used.

Examples of the complex hydride solid electrolytes that may be used include LiBH₄—LiI and LiBH₄—P₂S₅.

The electrolyte layer 202 may include the solid electrolyte as a main component.

The electrolyte layer 202 may include the solid electrolyte in a mass ratio of greater than or equal to 70% relative to the whole of the electrolyte layer 202.

The electrolyte layer 202 may include only the solid electrolyte.

The electrolyte layer 202 may include two or more of the materials described above as the solid electrolytes.

The shape of the solid electrolyte contained in the electrolyte layer 202 is not limited. For example, the shape of the solid electrolyte may be acicular, spherical, ellipsoidal, or fibers. For example, the shape of the solid electrolyte may be particulate. The solid electrolyte may be formed to have a pellet or plate shape.

When the solid electrolyte contained in the electrolyte layer 202 is particles (for example, spherical particles), the median diameter of the solid electrolyte may be greater than or equal to 0.1 μm and less than or equal to 100 μm. According to this configuration, the ion conductivity of the solid electrolyte can be enhanced. Furthermore, the solid electrolyte and other materials may be favorably dispersed in the electrolyte layer 202. Thus, the battery 2000 attains enhanced charge-discharge characteristics.

The median diameter of the solid electrolyte contained in the electrolyte layer 202 may be greater than or equal to 0.5 μm and less than or equal to 10 μm. According to this configuration, the ion conductivity of the solid electrolyte can be further enhanced.

The thickness of the electrolyte layer 202 may be greater than or equal to 1 μm and less than or equal to 1000 μm. When the thickness of the electrolyte layer 202 is greater than or equal to 1 μm, the first electrode 201 and the second electrode 203 are unlikely to be short circuited. When the thickness of the electrolyte layer 202 is less than or equal to 1000 μm, the battery 2000 may be operated at a high output.

The first electrode 201 may further include an active material other than the first active material 101 and the second active material 102. The first electrode 201 may include a positive electrode active material. The first electrode 201 may include only a positive electrode active material as the active material. For example, the positive electrode active material includes a material capable of occluding and releasing metal ions, such as lithium ions.

Examples of the positive electrode active materials include lithium-containing transition metal oxides, transition metal fluorides, polyanion materials, fluorinated polyanion materials, transition metal sulfides, transition metal oxysulfides, and transition metal oxynitrides. Examples of the lithium-containing transition metal oxides include Li(Ni,Co,Al)O₂, Li(Ni,Co,Mn)O₂, and LiCoO₂. In particular, the use of a lithium-containing transition metal oxide as the positive electrode active material advantageously saves the production cost and increases the average discharge voltage. To increase the energy density of the battery 2000, the positive electrode active material may include lithium nickel cobalt manganate. For example, the positive electrode active material may be Li(Ni,Co,Mn)O₂.

In the present disclosure, the notation “(A,B,C)” in a formula means “at least one selected from the group consisting of A, B, and C”. For example, “(Ni,Co,Al)” is synonymous with “at least one selected from the group consisting of Ni, Co, and Al”.

The first electrode 201 may further include a solid electrolyte. According to this configuration, the first electrode 201 can attain enhanced ion conductivity and thereby can offer enhanced output characteristics of the battery 2000.

The solid electrolyte contained in the first electrode 201 may be a halide solid electrolyte, a sulfide solid electrolyte, an oxide solid electrolyte, a polymeric solid electrolyte, or a complex hydride solid electrolyte.

The halide solid electrolyte, the sulfide solid electrolyte, the oxide solid electrolyte, the polymeric solid electrolyte, or the complex hydride solid electrolyte that is used may be a material described as the solid electrolyte contained in the electrolyte layer 202.

The second electrode 203 may further include an active material other than the first active material 101 and the second active material 102. The second electrode 203 may include a negative electrode active material. The second electrode 203 may include only a negative electrode active material as the active material. For example, the negative electrode active material includes a material capable of occluding and releasing metal ions, such as lithium ions.

Examples of the negative electrode active materials include metal materials, carbon materials, oxides, nitrides, tin compounds, and silicon compounds. The metal materials may be elemental metals. The metal materials may be alloys. Examples of the metal materials include lithium metal and lithium alloys. Examples of the carbon materials include natural graphite, cokes, semi-graphitized carbon, carbon fibers, spherical carbon, artificial graphite, and amorphous carbon. The capacity density of the battery 2000 can be enhanced by using, for example, silicon (Si), tin (Sn), a silicon compound, or a tin compound.

The second electrode 203 may further include a solid electrolyte. According to this configuration, the second electrode 203 can attain enhanced ion conductivity and thereby can offer enhanced output characteristics of the battery 2000.

The solid electrolyte contained in the second electrode 203 may be a halide solid electrolyte, a sulfide solid electrolyte, an oxide solid electrolyte, a polymeric solid electrolyte, or a complex hydride solid electrolyte.

The halide solid electrolyte, the sulfide solid electrolyte, the oxide solid electrolyte, the polymeric solid electrolyte, or the complex hydride solid electrolyte that is used may be a material described as the solid electrolyte contained in the electrolyte layer 202.

The shapes of the solid electrolytes contained in the first electrode 201 and the second electrode 203 are not limited. For example, the shapes of the solid electrolytes may be acicular, spherical, ellipsoidal, or fibers. For example, the shapes of the solid electrolytes may be particulate. The solid electrolytes may be formed to have a pellet or plate shape.

When the solid electrolytes contained in the first electrode 201 and the second electrode 203 are particles (for example, spherical particles), the median diameters of the solid electrolytes may be each greater than or equal to 0.1 μm and less than or equal to 100 μm. According to this configuration, the positive electrode active material and the solid electrolyte may be favorably dispersed in the first electrode 201, and the negative electrode active material and the solid electrolyte may be favorably dispersed in the second electrode 203. Thus, the battery 2000 attains enhanced charge-discharge characteristics.

The median diameters of the solid electrolytes contained in the first electrode 201 and the second electrode 203 may be each greater than or equal to 0.5 μm and less than or equal to 10 μm. According to this configuration, the positive electrode active material and the solid electrolyte may be more favorably dispersed in the first electrode 201, and the negative electrode active material and the solid electrolyte may be more favorably dispersed in the second electrode 203.

The shapes of the positive electrode active material and the negative electrode active material are not limited. For example, the shapes of the positive electrode active material and the negative electrode active material may be acicular, spherical, or ellipsoidal. For example, the shapes of the positive electrode active material and the negative electrode active material may be particulate.

When the positive electrode active material and the negative electrode active material are particles (for example, spherical particles), the median diameters of the positive electrode active material and the negative electrode active material may be each greater than or equal to 0.1 μm and less than or equal to 100 μm. When the median diameters of the positive electrode active material and the negative electrode active material are each greater than or equal to 0.1 μm, the positive electrode active material and the solid electrolyte may be favorably dispersed in the first electrode 201, and the negative electrode active material and the solid electrolyte may be favorably dispersed in the second electrode 203. Thus, the battery 2000 attains enhanced charge-discharge characteristics. When the median diameters of the positive electrode active material and the negative electrode active material are each less than or equal to 100 μm, the lithium diffusion rate in the first electrode 201 and the second electrode 203 is enhanced, thus allowing the battery 2000 to be operated at a high output.

The median diameters of the positive electrode active material and the negative electrode active material may be larger than the median diameters of the solid electrolytes. According to this configuration, the positive electrode active material and the solid electrolyte may be favorably dispersed in the first electrode 201, and the negative electrode active material and the solid electrolyte may be favorably dispersed in the second electrode 203.

The volume ratio “v3:100−v3” between the positive electrode active material and the solid electrolyte contained in the first electrode 201 may satisfy 30≤v3≤95. Here, v3 indicates the volume proportion of the positive electrode active material relative to the total volume of the positive electrode active material and the solid electrolyte in the first electrode 201 taken as 100. When 30≤v3 is satisfied, a sufficient energy density of the battery 2000 may be ensured. When v3≤95 is satisfied, the battery 2000 may be operated at a high output.

The volume ratio “v4:100−v4” between the negative electrode active material and the solid electrolyte in the second electrode 203 may satisfy 30≤v4≤95. Here, v4 indicates the volume proportion of the negative electrode active material relative to the total volume of the negative electrode active material and the solid electrolyte in the second electrode 203 taken as 100. When 30≤v4 is satisfied, a sufficient energy density of the battery 2000 may be ensured. When v4≤95 is satisfied, the battery 2000 may be operated at a high output.

At least one selected from the group consisting of the first electrode 201, the electrolyte layer 202, and the second electrode 203 may include a binder for the purpose of enhancing the adhesion of particles to one another. Binders are used to enhance the integrity of materials constituting an electrode. Examples of the binders include polyvinylidene fluoride, polytetrafluoroethylene, polyethylene, polypropylene, aramid resins, polyamide, polyimide, polyamidimide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyether sulfone, hexafluoropolypropylene, styrene butadiene rubber, and carboxymethylcellulose. Furthermore, the binder that is used may be a copolymer of two or more materials selected from the group consisting of tetrafluoroethylene, hexafluoroethylene, hexafluoropropylene, perfluoroalkyl vinyl ethers, vinylidene fluoride, chlorotrifluoroethylene, ethylene, propylene, pentafluoropropylene, fluoromethyl vinyl ether, acrylic acid, and hexadiene. A mixture of two or more materials selected from the above materials may also be used as the binder.

At least one of the first electrode 201 or the second electrode 203 may include a conductive auxiliary for the purpose of enhancing the electron conductivity. Examples of the conductive auxiliaries that may be used include graphites, such as natural graphites and artificial graphites; carbon blacks, such as acetylene blacks and Ketjen blacks; conductive fibers, such as carbon fibers and metal fibers; carbon fluoride; metal powders, such as aluminum; conductive whiskers, such as zinc oxide and potassium titanate; conductive metal oxides, such as titanium oxide; and conductive polymer compounds, such as polyaniline, polypyrrole, and polythiophene. The cost can be reduced by using a carbon conductive auxiliary as the conductive auxiliary.

Examples of the shapes of the batteries 2000 include coin shapes, cylindrical shapes, prismatic shapes, sheet shapes, button shapes, flat shapes, and laminate shapes.

### Battery Manufacturing Methods

For example, the battery 2000 may be manufactured by the following method. As an example, the method for manufacturing the battery 2000 described below assumes that the second electrode 203 includes the electrode material 1000 in Embodiment 1.

A material for forming the first electrode 201, a material for forming the electrolyte layer 202, and the electrode material 1000 as a material for forming the second electrode 203 are provided. By a known method, a stack is fabricated in which the first electrode 201, the electrolyte layer 202, and the second electrode 203 are arranged in this order. A battery 2000 is thus obtained.

The solid electrolyte contained in the first electrode 201, and the solid electrolyte contained in the electrolyte layer 202 may be produced by the same method as the method for producing the solid electrolyte 104 described in the method for producing the electrode material 1000 in Embodiment 1.

### EXAMPLES

The present disclosure will be described in detail below based on EXAMPLES and COMPARATIVE EXAMPLES. The EXAMPLES below are only illustrative and do not limit the scope of the present disclosure thereto.

### Example 1

### Preparation of Solid Electrolyte

In an argon atmosphere having a dew point of less than or equal to −60° C. (hereinafter, written as “dry argon atmosphere”), ingredient powders LiBr, LiCl, LiI, YCl₃, and YBr₃ were weighed out so that the molar ratio Li:Y:Br:Cl:I would be 3:1:2:2:2. The ingredient powders were pulverized and mixed in a mortar to give a mixture. Subsequently, the mixture was milled using a planetary ball mill (P-7 manufactured by Fritsch Japan Co., Ltd.) at 600 rpm for 25 hours. Thus, a powder of Li₃YBr₂Cl₂I₂ was obtained as a solid electrolyte of EXAMPLE 1.

### Preparation of Electrode Material

Li₄Ti₅O₁₂ (manufactured by Toshima Manufacturing Co., Ltd.) was used as a first active material. MoO₂ (manufactured by Kojundo Chemical Lab. Co., Ltd.) was used as a second active material. Vapor-grown carbon fibers (VGCF-H manufactured by Showa Denko K.K.) were used as a conductive auxiliary. In a dry argon atmosphere, the solid electrolyte of EXAMPLE 1, the first active material, the second active material, and the conductive auxiliary were weighed out so that the mass ratio would be 29.7:51.4:17.2:1.7. These materials were mixed in a mortar. Thus, an electrode material of EXAMPLE 1 was obtained. In the electrode material of EXAMPLE 1, the mass ratio of the first active material to the second active material was 75:25. “VGCF” is a registered trademark of Showa Denko K.K.

### Fabrication of Battery

The electrode material obtained above was used as a material for forming a first electrode. Solid electrolyte Li₆PS₅Cl (manufactured by MSE Supplies LLC) was used as a material for forming an electrolyte layer. 21.0 mg of the electrode material and 80 mg of Li₆PS₅Cl were weighed out. The electrode material and Li₆PS₅Cl were stacked in this order in an electrically insulating external cylinder and were compacted at 720 MPa. Thus, a stack consisting of a first electrode and an electrolyte layer was fabricated. Next, In metal with a thickness of 200 μm, Li metal with a thickness of 300 μm, and In metal with a thickness of 200 μm were arranged in this order on the electrolyte layer of the stack. The unit was pressed at a pressure of 80 MPa to give a trilaminar stack consisting of the first electrode, the electrolyte layer, and an In—Li—In layer. Next, stainless-steel current collectors were arranged on both sides of the trilaminar stack, and current collector leads were attached to the current collectors. Lastly, the inside of the electrically insulating external cylinder was isolated from the outside atmosphere and was sealed with use of an electrically insulating ferrule. A battery of EXAMPLE 1 was thus fabricated.

### Example 2

An electrode material and a battery of EXAMPLE 2 were produced in the same manner as in EXAMPLE 1 except that the solid electrolyte, the first active material, the second active material, and the conductive auxiliary were weighed out in the preparation of the electrode material so that the mass ratio would be 26.9:35.8:35.8:1.5. In the electrode material of EXAMPLE 2, the mass ratio of the first active material to the second active material was 50:50.

### Comparative Example 1

An electrode material and a battery of COMPARATIVE EXAMPLE 1 were produced in the same manner as in EXAMPLE 1 except for the following. The second active material (MoO₂) was not used in the preparation of the electrode material. Specifically, the mass ratio of the first active material to the second active material in the electrode material of COMPARATIVE EXAMPLE 1 was 100:0. The solid electrolyte, the first active material, and the conductive auxiliary were weighed out so that the mass ratio would be 32.3:65.8:1.9.

### Comparative Example 2

An electrode material and a battery of COMPARATIVE EXAMPLE 2 were produced in the same manner as in EXAMPLE 1 except for the following. The first active material (Li₄Ti₅O₁₂) was not used in the preparation of the electrode material. Specifically, the mass ratio of the first active material to the second active material in the electrode material of COMPARATIVE EXAMPLE 2 was 0:100. The solid electrolyte, the second active material, and the conductive auxiliary were weighed out so that the mass ratio would be 20.4:78.4:1.2.

### Evaluation of Composition of Solid Electrolyte

The solid electrolyte of EXAMPLE 1 was analyzed by ICP (inductively coupled plasma) emission spectrometry to determine the composition. The deviation from the composition estimated from the Li/Y feed was within 3%. From this result, it can be said that the composition of the solid electrolyte obtained was almost the same as the composition estimated from the feed to the planetary ball mill.

### Charge-Discharge Test

Next, the batteries of EXAMPLES 1 and 2 and COMPARATIVE EXAMPLES 1 and 2 were subjected to a charge-discharge test under the following conditions.

The battery was placed in a thermostatic chamber at 25° C. The battery was charged at a constant current of 115 μA. The charging was terminated when the potential vs. Li reached 1.0 V. Next, the battery was discharged at a constant current of 115 μA, and the discharging was terminated when the potential vs. Li reached 2.5 V. Based on the results of the charge-discharge test described above, the discharge capacity in 115 μA discharging was obtained, and the charge-discharge efficiency in 115 μA charging and discharging was calculated. The results are described in Table 1.

TABLE 1

| | | | | Charge-discharge |
|---|---|---|---|---|
| | Mass ratio | Mass ratio | Discharge | efficiency |
| | of first | of second | capacity | in 115 μA |
| | active | active | in 115 μA | charging and |
| | material | material | discharging | discharging |
| | (%) | (%) | (mAh/g) | (%) |
| COMPAR- | 100 | 0 | 164 | 98.9 |
| ATIVE | | | | |
| EXAMPLE 1 | | | | |
| EXAMPLE 1 | 75 | 25 | 166.1 | 98.8 |
| EXAMPLE 2 | 50 | 50 | 170.8 | 97.0 |
| COMPAR- | 0 | 100 | 177.8 | 93.2 |
| ATIVE | | | | |
| EXAMPLE 2 | | | | |

### DISCUSSION

The active materials in EXAMPLES 1 and 2 each included the first active material and the second active material. As described in Table 1, the batteries of EXAMPLES 1 and 2 had high values of discharge capacity and charge-discharge efficiency. As demonstrated above, EXAMPLES 1 and 2 satisfied both charge-discharge efficiency and discharge capacity.

As described in Table 1, the discharge capacity increased with increasing ratio of the mass of the second active material to the total mass of the first active material and the second active material. The charge-discharge efficiency decreased with increasing ratio of the mass of the second active material to the total mass of the first active material and the second active material.

The above results are explained below. The second active material MoO₂ reacts with lithium reversibly in the same potential range as the first active material Li₄Ti₅O₁₂. The density and the capacity per mass of MoO₂ are 6.47 g/cm³ and 209 mAh/g. That is, MoO₂ has a high energy density per volume compared to Li₄Ti₅O₁₂. Thus, partial substitution of Li₄Ti₅O₁₂ with MoO₂ increased the energy density per volume of the battery, and the discharge capacity per mass of the battery was enhanced as a result. On the other hand, MoO₂ has low charge-discharge efficiency compared to Li₄Ti₅O₁₂. Thus, the charge-discharge efficiency of the battery decreased with increasing mass ratio of the second active material.

From the above results, it can be seen that the discharge capacity per mass of the battery and also the charge-discharge efficiency can be enhanced at the same time by, in particular, appropriately controlling the ratio of the mass of the first active material to the total mass of the first active material and the second active material.

The first active material Li₄Ti₅O₁₂ expands less and contracts less than the second active material MoO₂ upon insertion and extraction of lithium ions. In EXAMPLE 1, the ratio of the mass of the first active material to the total mass of the first active material and the second active material was 75%. Thus, EXAMPLE 1 attained higher battery safety than EXAMPLE 2 while satisfying both battery charge-discharge efficiency and battery discharge capacity.

### Example 4

### Preparation of Solid Electrolyte

In a dry argon atmosphere, ingredient powders LiBr, YBr₃, LiCl, and YCl₃ were weighed out so that the molar ratio Li:Y:Br:Cl would be 3:1:2:4. The ingredient powders were pulverized and mixed in a mortar to give a mixture. Subsequently, the mixture was milled using a planetary ball mill (P-7 manufactured by Fritsch Japan Co., Ltd.) at 600 rpm for 25 hours. Thus, a powder of Li₃YBr₂Cl₄ was obtained as a solid electrolyte of EXAMPLE 4.

### Preparation of Positive Electrode Material

Li(Ni,Co,Mn)O₂ was used as a positive electrode active material. Vapor-grown carbon fibers (VGCF-H manufactured by Showa Denko K.K.) were used as a conductive auxiliary. In a dry argon atmosphere, the positive electrode active material, the solid electrolyte of EXAMPLE 4, and the conductive auxiliary were weighed out so that the mass ratio would be 83:16:1. These materials were mixed in a mortar. Thus, a positive electrode material of EXAMPLE 4 was obtained.

### Fabrication of Battery

The electrode material of EXAMPLE 1 was used as a negative electrode material. 14.0 mg of the negative electrode material, 80 mg of the solid electrolyte of EXAMPLE 4, and 8.5 mg of the positive electrode material were weighed out. The negative electrode material, the solid electrolyte of EXAMPLE 4, and the positive electrode material were stacked in this order in an electrically insulating external cylinder and were compacted at 720 MPa. Thus, a stack consisting of a positive electrode, an electrolyte layer, and a negative electrode was fabricated. Next, stainless-steel current collectors were arranged on both sides of the stack, and current collector leads were attached to the current collectors. Lastly, the inside of the electrically insulating external cylinder was isolated from the outside atmosphere and was sealed with use of an electrically insulating ferrule. A battery of EXAMPLE 4 was thus fabricated.

### Charge-Discharge Test

Next, the battery of EXAMPLE 4 was subjected to a charge-discharge test under the following conditions.

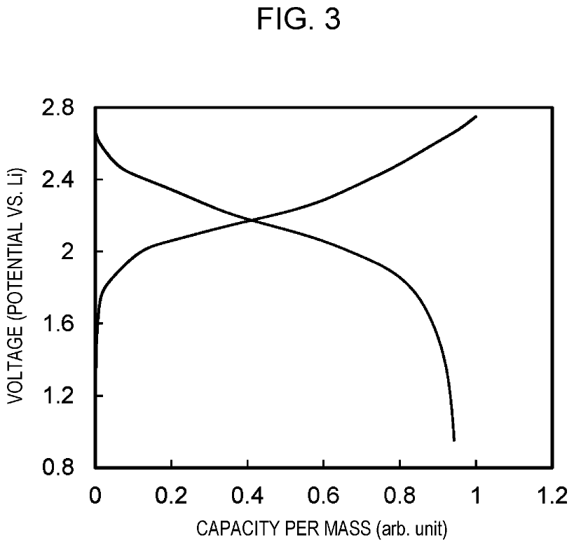

The battery was placed in a thermostatic chamber at 25° C. The battery was charged at a constant current of 64 μA. The charging was terminated when the potential vs. Li reached 2.75 V. Next, the battery was discharged at a constant current of 64 μA, and the discharging was terminated when the potential vs. Li reached 0.95 V. The results are illustrated in FIG. 3.

### DISCUSSION

FIG. 3 is a graph illustrating the results of the initial charge-discharge test of the battery of EXAMPLE 4. In FIG. 3, the ordinate indicates voltage (V) and the abscissa indicates capacity per mass (arbitrary unit). In EXAMPLE 4, Li₃YBr₂Cl₄ was used as the solid electrolyte contained in the positive electrode material and as the solid electrolyte for the electrolyte layer. Li₃YBr₂Cl₂I₂ was used as the solid electrolyte contained in the negative electrode material. That is, the solid electrolytes used in the battery of EXAMPLE 4 contained Li, M, and X. In the solid electrolytes, M is at least one selected from the group consisting of metal elements except Li, and metalloid elements, and X is at least one selected from the group consisting of F, Cl, Br, and I. From the results illustrated in FIG. 3, it has been shown that the battery using the above materials alone as the solid electrolytes can operate stably. Furthermore, the solid electrolytes in the battery of EXAMPLE 4 did not contain sulfur. Thus, the battery of EXAMPLE 4 was free from generation of hydrogen sulfide gas and attained enhanced battery safety.

For example, the battery of the present disclosure may be used as an all-solid-state lithium secondary battery.

What is claimed is:

1. An electrode material comprising:
a first active material containing Li, Ti, and O;
a second active material containing Mo and O; and
a solid electrolyte.

2. The electrode material according to claim 1, wherein
the ratio of the mass of the first active material to the total mass of the first active material and the second active material is greater than or equal to 50% and less than or equal to 99%.

3. The electrode material according to claim 2, wherein
the ratio is greater than or equal to 70% and less than or equal to 95%.

4. The electrode material according to claim 1, wherein
the first active material comprises lithium titanium oxide.

5. The electrode material according to claim 4, wherein
the lithium titanium oxide comprises Li₄Ti₅O₁₂.

6. The electrode material according to claim 1, wherein
the second active material comprises molybdenum oxide.

7. The electrode material according to claim 6, wherein
the molybdenum oxide comprises MoO₂.

8. The electrode material according to claim 1, wherein
the solid electrolyte contains Li, M, and X,
M is at least one selected from the group consisting of metal elements except Li, and metalloid elements, and
X is at least one selected from the group consisting of F, Cl, Br, and I.

9. The electrode material according to claim 8, wherein
the solid electrolyte is represented by formula (1) below:
Li_{α}M_{β}X_{γ} Formula (1)
wherein α, β, and γ are each independently a value greater than 0.

10. The electrode material according to claim 9, wherein
the solid electrolyte comprises Li₃YBr₂Cl₂I₂.

11. The electrode material according to claim 8, wherein
the solid electrolyte does not contain sulfur.

12. A battery comprising:
a first electrode;
a second electrode; and
an electrolyte layer arranged between the first electrode and the second electrode, wherein
at least one selected from the group consisting of the first electrode and the second electrode comprises the electrode material described in claim 1.
